(19) United States
(12) Patent Application Publication
(10) Pub. No.: US 2026/0171100 A1
(43) Pub. Date: Jun. 18, 2026

(54) REPRESENTING AUDIO CHANNELS AND OBJECTS IN A CONTAINER FORMAT

(71) Applicant: GOOGLE LLC, Mountain View, CA (US)

(72) Inventors: Sze Chie Lim, Mountain View, CA (US); Joseph Cullen, Levittown, NY (US); Shawn Singh, Palo Alto, CA (US); Francis Galligan, Los Gatos, CA (US); Jan Skoglund, San Francisco, CA (US)

(21) Appl. No.: 19/418,640

(22) Filed: Dec. 12, 2025

Related U.S. Application Data
(60) Provisional application No. 63/734,835, filed on Dec. 17, 2024.

(51) Int. Cl. G10L 19/008; G10L 19/08

(52) U.S. Cl. CPC G10L 19/008; G10L 19/08

(57) ABSTRACT

A method including generating a codec agnostic container including a first parameter, the first parameter including metadata describing how to render audio from a position in three-dimensional space, generating a codec dependent container including a second parameter, the second parameter including information associated with an audio codec used to compress data corresponding to the audio, and generating an audio package, the audio package including the codec agnostic container, the codec dependent container, and the compressed data corresponding to the audio.

### CROSS-REFERENCE TO RELATED APPLICATION

This application claims priority to U.S. Provisional Patent Application No. 63/734,835, filed on Dec. 17, 2024, entitled “REPRESENTING AUDIO CHANNELS AND OBJECTS IN A CONTAINER FORMAT”, the disclosure of which is incorporated by reference herein in its entirety.

### FIELD

Implementations relate to generating an audio package for playing back audio on a playback device.

### BACKGROUND

Streaming audio data can include streaming audio to a playback device. The playback device can include one (e.g., mono) or more (e.g., stereo, surround sound) speakers. Therefore, the streaming audio data can include one or more channels. Conventional channel-based audio can have one audio signal mapped to every speaker.

### SUMMARY

Implementations include a flexible and efficient system for packaging and delivering immersive audio. The central innovation is to treat every sound (e.g., whether it is dialogue from a fixed speaker or a helicopter flying overhead) as a basic audio stream accompanied by a separate set of instructions, or ‘metadata.’ This metadata tells a playback device precisely how to present the sound in three-dimensional space. For example, a filmmaker can create a single audio file for a movie's dialogue. For a home theater system, the metadata instructs the system to play it from the center speaker. For a headphone user, different metadata can be used to render the exact same dialogue to sound like an intimate whisper right next to the listener's ear. This approach avoids the need to create and store multiple large audio files, significantly saving bandwidth and storage space, while giving content creators precise control and ensuring a desired experience on any device.

An immersive audio (IA) package disclosed herein is designed to represent IA for presentation on a wide range of devices in both dynamic streaming and offline applications. These applications include internet audio streaming, multicasting/broadcasting services, file download, gaming, communication, virtual and augmented reality, and others. In these applications, audio may be played back on a wide range of devices, e.g., headsets, mobile phones, tablets, TVs, sound bars, home theater systems and big screens. Streaming can include an audio package having a number of coded audio substreams and container(s) including information that describes how to decode, render, and mix the substreams to generate an audio signal for playback. The containers separate codec agnostic rendering parameters from codec-specific decoding parameters. This decoupling of rendering metadata from the audio frame timeline is what enables creator control over the timing of the automation data and allows for bitstream manipulations such as transcoding, merging, and concatenation without requiring that automation data be re-timed or re-partitioned. In some implementations, automation data can refer to the time-varying parameters (e.g., metadata) that a content creator defines in an authoring tool, such as a Digital Audio Workstation (DAW), to control how a sound behaves over time. These parameters can include changes in volume, spatial position, and other audio effects that are applied dynamically during playback. The IA package including streaming audio is codec agnostic; any supported audio codec may be used to code the audio substreams.

In a general aspect, a device, a system, a non-transitory computer-readable medium (having stored thereon computer executable program code which can be executed on a computer system), and/or a method can perform a process with a method including generating a codec agnostic container including a first parameter, the first parameter including metadata describing how to render audio from a position in three-dimensional space, generating a codec dependent container including a second parameter, the second parameter including information associated with an audio codec used to compress data corresponding to the audio, and generating an audio package, the audio package including the codec agnostic container, the codec dependent container, and the compressed data corresponding to the audio.

### BRIEF DESCRIPTION OF THE DRAWINGS

Example implementations will become more fully understood from the detailed description given herein below and the accompanying drawings, wherein like elements are represented by like reference numerals, which are given by way of illustration only and thus are not limiting of the example implementations.

FIG. 1A illustrates a block diagram of a data flow for generating an audio package according to an example implementation.

FIG. 1B illustrates a block diagram of a data flow for generating an audio presentation according to an example implementation.

FIG. 2A illustrates a block diagram of containers according to an example implementation.

FIGS. 2B and 2C illustrate block diagrams of a payload according to an example implementation.

FIG. 2D illustrates another block diagram of a packet according to an example implementation.

FIG. 3 illustrates a block diagram of a data flow for generating an audio package according to an example implementation.

FIG. 4 is a block diagram of a method of generating an audio package according to an example implementation.

It should be noted that these Figures are intended to illustrate the general characteristics of methods, and/or structures utilized in certain example implementations and to supplement the written description provided below. These drawings are not, however, to scale and may not precisely reflect the precise structural or performance characteristics of any given implementation and should not be interpreted as defining or limiting the range of values or properties encompassed by example implementations. For example, the positioning of modules and/or structural elements may be reduced or exaggerated for clarity. The use of similar or identical reference numbers in the various drawings is intended to indicate the presence of a similar or identical element or feature.

### DETAILED DESCRIPTION

Some implementations include a unified and highly efficient framework for creating and delivering immersive audio experiences across a wide range of applications, from streaming movies to interactive virtual reality (VR). Some implementations can separate the audio content itself from the instructions that describe how it should be rendered in a 3D space. This decoupling allows for significant flexibility and optimization, as illustrated by the following non-technical examples.

An immersive audio scene in a virtual reality (VR) application can be rendered relative to the user's head orientation. A sound source, such as a virtual speaker playing music, can be defined by a single audio substream and its position metadata. As the user turns their head, the renderer can use the static position metadata to dynamically re-calculate the sound's location in the binaural field, providing a realistic and responsive spatial audio experience without requiring complex audio processing at the source.

Another use for immersive audio can be video gaming and/or virtual reality. A game developer could create a sound effect for footsteps and store the compressed audio once. As a character moves around the virtual environment, the system can generate new, lightweight metadata to update the position of the footstep sounds in real-time. This can be more efficient than having separate, pre-rendered audio files for every possible location. Some implementations can include an audio package structure configured to ensure that the rendering instructions (the metadata) are kept separate from the audio compression format, allowing for greater flexibility across different platforms and devices

At least one technical problem with existing immersive audio container formats, including those utilized by systems like conventional object-based audio formats (e.g., Dolby Atmos and MPEG-H), is their reliance on a rigid, dualistic architecture that separates traditional, label-based channel-beds from dynamic audio objects. While these formats support object-based audio, they remain anchored to a predefined system for the channel bed (e.g., 5.1, 7.1.4), lacking a unified mechanism to signal audio channels for arbitrary speaker positions or to treat all sound sources within a single, consistent framework. For instance, if a content creator wishes to place a sound source at an intermediate position not aligned with a standard speaker label, these formats provide no direct method for signaling this high-precision spatial information within the channel-bed paradigm. This forces creators into computationally expensive and data-inefficient workarounds, such as pre-rendering numerous distinct channel-based mixes for different speaker layouts. This approach results in significant data redundancy, complicates rendering pipelines by requiring separate processing paths for channels and objects, and increases distribution costs due to the bandwidth and storage overhead required to deliver multiple versions.

In addition, existing metadata signaling schemes, such as the Audio Definition Model (ADM) specified in ITU-R BS.2076, present limitations for efficient, streamable delivery of dynamic audio. While ADM supports timed metadata through its ‘audioBlockFormat,’ it is not designed for streaming applications where bitrate efficiency and random access (seeking) are critical. The ADM framework does not specify how to handle non-contiguous gaps in the metadata timeline, forcing continuous data transmission even when parameters are static or inactive, which inflates the bitrate. Its structure is ill-suited for low-latency streaming and does not inherently provide mechanisms for clean seek points within the metadata stream. This creates a technical problem for delivering complex, dynamic immersive audio experiences in bandwidth-constrained environments like mobile streaming or broadcasting.

At least one technical solution to the technical problem can be to represent audio channels and objects in a unified way by signaling both as a mono or stereo audio channel accompanied by discrete, time-stamped metadata. This metadata, carried in dedicated parameter blocks, describes how to render the channel so that it appears from the intended position in space and with the intended attributes (e.g., as a large diffuse sound source), instead of signaling the speaker channels explicitly through a list of labels.

For example, some implementations can provide a flexible and efficient framework for representing complex, immersive audio experiences. This system unifies the treatment of traditional channel-based audio (like a 5.1 surround sound setup) and dynamic object-based audio (like a helicopter flying overhead). Instead of using rigid channel labels, some implementations can represent every sound element, whether a fixed speaker channel or a moving object, as a basic mono or stereo audio stream accompanied by descriptive metadata. This metadata can specify how the sound should be rendered in three-dimensional space, including its position, size, and other attributes.

This approach can offer significant advantages for content creators and consumers alike. For example, a filmmaker can create a single audio package that includes multiple mix presentations. One presentation can, for example, place a dialogue track in a standard central position for a home theater system. Another presentation, intended for headphone listeners, can, for example, use the exact same compressed audio data but reference different metadata to place the dialogue closer to the listener for a more intimate feel. This can be achieved without duplicating the core audio, saving significant file space and bandwidth.

This flexibility extends to managing asynchronous audio streams, which is common in complex productions where different audio elements might have different frame rates or timings. The system can package these streams together, using the metadata to ensure they are correctly synchronized during playback, without needing to transcode or re-time everything to a common format. This simplifies the production workflow and preserves the original quality of the audio assets.

To achieve this, some implementations extend the concept of Parameter Blocks, which carry time-varying metadata, and Parameter Definitions, which define the properties of that metadata. A parameter definition can specify default rendering values (e.g., a default position) and introduce bit-saving features. For example, to reduce bitrate for animation data, a system can provide multiple parameter definitions for the same metadata type, each with a different multiplication factor. This selection can be made by the content creator within an authoring tool, which analyzes the dynamic range of the automation data and suggests a parameter definition. For a parameter definition, a corresponding multiplication factor may be defined. Therein, multiplying, by the multiplication factor according to the parameter definition, a signaled integer value representing a value of a certain parameter to which the parameter definition pertains may yield the (quantized) corresponding value, e.g., floating-point value, of said parameter. Thus, the parameter definition and its multiplication factor may enable representing a (quantized) parameter value, e.g., of a floating-point parameter, by an integer value.

To implement this bit-saving feature, the preprocessor 105 can be configured to automatically determine the most efficient multiplication factor by executing a selection algorithm on the metadata values for a given segment. For instance, the algorithm first calculates two metrics from the automation data: the maximum absolute value (max_val) and the minimum step size (min_step), where min_step is the smallest non-zero difference between any two consecutive values in the segment. With these metrics, the algorithm iterates through a list of available parameter definitions, ordered by their multiplication factors from smallest to largest. For each definition, it checks two conditions: first, whether the definition's representable range (determined by its bit depth) can accommodate max_val without overflow, and second, whether its precision (determined by the multiplication factor) can represent min_step without quantizing it to zero. The first parameter definition that satisfies both conditions is selected, thereby providing the minimum bitrate required to represent the automation data with sufficient range and precision to preserve the creator's original intent.

This process can select the definition that provides the required precision with the minimum number of bits. To represent a sound moving from left to right along a horizontal axis from −1.0 to +1.0, instead of sending full-precision floating-point coordinates for every audio frame, a creator could select a parameter definition with a multiplication factor of 0.01. The system would then only need to send small integer values (e.g., −100 to +100) in the parameter blocks. The decoder, referencing the selected parameter definition, multiplies the received integer value by 0.01 to reconstruct the high-precision coordinate. By selectively applying different parameter definitions with optimized multiplication factors based on the required precision for a given scene, the system can significantly reduce the data overhead for animation metadata.

Further efficiency can be gained by allowing gaps to exist in the timeline of these parameter blocks. If a sound remains static for a period, no new parameter blocks need to be sent; in this case, the renderer simply continues to use the last known value from the most recent parameter block. This avoids redundant data transmission for static parameters. Similarly, the duration of a parameter block can be decoupled from the audio frame duration, allowing a single block of metadata to apply across a span of multiple audio frames. This ability to signal metadata at varying rates (e.g., only when needed) can significantly reduce the overall bitrate compared to systems that require continuous metadata transmission, making the format more efficient for both streaming and storage. In some implementations, an aspect of this efficiency is that different parameter streams can be signaled using independent modes simultaneously. For example, within a single audio presentation, metadata for a static background object's position could be sent once at the beginning of a scene, while the gain parameter for a foreground dialogue track is updated at a high, continuous rate. This allows an encoder to select the most efficient signaling strategy on a per-parameter basis, tailoring the data rate to the specific requirements of each element in the mix without being constrained to a single mode for all active metadata.

By treating every sound element as a basic audio stream accompanied by descriptive metadata, some implementations can provide a unified technical solution to the above-indicated problems for delivering complex, dynamic immersive audio experiences in bandwidth-constrained environments. An audio channel intended for an arbitrary speaker position can be represented as a mono audio stream with static metadata defining its specific azimuth and elevation. For example, a content creator may be mixing for a custom art installation with a speaker placed high on a wall at an unusual angle (e.g., azimuth 65°, elevation) 45°. Instead of being forced to approximate this position using a standard 7.1.4 layout, the disclosed system allows the creator to signal these exact coordinates in the metadata. A dynamic audio object can be represented similarly, but with time-varying metadata that describes its movement. This unified approach can eliminate the need for predefined channel labels and allows for infinite positioning flexibility. Furthermore, by placing this rendering metadata into parameter blocks whose timing is decoupled from the underlying audio frames, the system can efficiently signal changes. Metadata is only transmitted when it changes, and a default rendering state can be defined for any gaps, significantly reducing bitrate overhead while supporting complex, dynamic audio scenes.

Further, in some implementations, a renderer (e.g., on a user device) can use metadata to place the mono/stereo audio channel in space with the appropriate position and process the signal to apply other metadata. The metadata can represent size, diffuseness, directivity, and/or the like. For example, in the case of a speaker channel, the metadata can include position information (or any additional information should be set so that no additional rendering processing is applied). The disclosed metadata format provides a direct, normalized input for common rendering algorithms, bypassing the need for lookup tables or complex logic to translate channel labels into spatial coordinates.

For example, position may be signaled as floating-point values for azimuth (e.g., from −180 to +180 degrees) and elevation (e.g., from −90 to +90 degrees). For instance, the renderer could employ a Vector Base Amplitude Panning (VBAP) algorithm. The renderer would first convert the azimuth and elevation metadata into a 3D Cartesian unit vector (e.g., using the standard spherical coordinate transformation: x=cos (azimuth)*cos (elevation), y=sin (azimuth)*cos (elevation), z=sin (elevation)). This vector is then used as a direct input to the VBAP algorithm to determine the precise gain values required for each speaker in the playback layout to create a phantom source at the intended location. Alternatively, for a scene represented using higher-order ambisonics, the renderer could decode the positional metadata to generate the appropriate ambisonic coefficients for the audio object, integrating it seamlessly into the overall soundfield before final rendering to the listener's speaker configuration. Then, the renderer can effectively provide a playable audio signal that is the same compared to a renderer which takes in an explicitly labelled mono/stereo audio channel.

By choosing to place the metadata in Mix Presentations, example implementations include a technique to signal how the same input audio substream can be rendered differently in different Mix Presentations. For example, the same object can appear closer or further away in two different Mix Presentations. For example, a stereo pair can be placed at the L/R locations or Ls/Rs location, i.e., left side and right side locations, in two different Mix Presentations to create a narrower or wider effect. Significant bit-rate savings can be achieved as the Mix Presentations can refer to the same audio substreams, which need be present in the bitstream only once, with only a small amount of additional parameter bitrate overhead incurred. The techniques for signaling this metadata efficiently to reduce overall bitrates include, for example, the use of multiplication factors in parameter definitions (as described above) and the signaling of metadata only when values change (as described above).

At least one technical effect of the technical solution can be the creation of a highly flexible and efficient audio representation framework. By representing sound elements as audio substreams decoupled from their spatial rendering metadata, some implementations provide a unified solution for both channel-based and object-based audio. This modularity can enable content creators precise control over the 3D soundscape, freeing them from the constraints of predefined speaker layouts. For example, this unified data model enables a significantly simplified renderer architecture, as a single processing pipeline can handle all sound sources without the need for separate logic for channel beds and dynamic objects.

Some implementations can further yield significant efficiency gains by enabling the reuse of compressed audio data across multiple mix presentations, language tracks, or editorial versions, which can reduce file size and streaming bandwidth. For the end-user, this architecture can ensure that the creator's spatial intent is accurately translated and rendered on any playback system, from binaural headphones to complex multi-speaker installations. This approach provides a single, scalable format that overcomes the rigidity and inefficiencies of previous systems, enabling more dynamic, interactive, and immersive audio experiences.

Some implementations can reduce memory and storage usage. For example, the system can enable the reuse of compressed audio data across multiple mix presentations. This eliminates the data redundancy inherent in prior art methods, directly reducing the computer memory and storage footprint required for complex audio projects.

Some implementations can improve processing efficiency. For example, by decoupling the metadata timeline from the audio frame timeline, the system can merge and synchronize asynchronous streams without computationally expensive transcoding or retiming operations, thus reducing the processing load on the CPU.

Some implementations can increase data transmission efficiency. For example, the system can use rule-based algorithms to reduce bitrate, such as selectively applying multiplication factors and transmitting metadata only when values change. This can conserve network bandwidth, a critical technical challenge in streaming applications.

Some implementations can improve computer functionality. For example, the unified, coordinate-based representation can enable the computer to render audio on any playback system, including arbitrary and non-standard speaker layouts, without requiring pre-rendered mixes. This can be an improvement to the capability of the rendering system itself.

Three-dimensional (3D) audio scenes can be flexibly automated to reflect a content creator's intent. Codec agnostic containers enable decoupling timing or other audio parameters from a single audio stream's frame rate or from the audio codec used. Routing 3D audio scenes from content creation through distribution through user playback devices often require processing by more than one service and/or system. Techniques can include generating asynchronous multi-stream audio representations using a common standalone representation that is agnostic of container formats or transport formats.

Accordingly, example implementations describe generating an audio package, including coded audio substreams and containers including parameters, that describes how to decode, render, and mix the substreams to generate an audio signal for playback. Example implementations describe containers including synchronous and asynchronous audio streams/substreams as a synchronous and an asynchronous multi-stream package. The multi-stream package can include audio packages configured to enable merging and processing of one or more input streams, without requiring transcoding and retiming to align the input streams.

Asynchronous multi-streams refer to audio streams that do not have the same frame sizes or do not have aligned frame boundaries. Example implementations describe techniques for communicating multi-stream audio including asynchronous multi-streams.

Example implementations describe audio streams including an audio package with codec agnostic and codec dependent containers. The audio package can convey immersive audio from content creation, multiple applications, and networked audio manipulations, through distribution, operating system audio frameworks, to a user's playback system. Therein, the codec agnostic container includes a first parameter, the first parameter including metadata describing how to render audio in three-dimensional space, the metadata including at least one of a position, a size, a directivity or a diffuseness attribute. The codec dependent container includes a second parameter, the second parameter including information associated with an audio codec used to compress data corresponding to the audio. The codec agnostic container being codec agnostic may correspond to the first parameter and the metadata included in it being independent of the audio codec used to compress the data corresponding to the audio.

The audio package can include multiple audio streams that are coded with two or more codecs. In this case, the audio package may for instance include, for each of the multiple audio streams, respective compressed data corresponding to the audio of the audio stream and a respective codec dependent container, the codec dependent container including a second parameter, the second parameter including information associated with an audio codec used to compress data corresponding to the audio of the audio stream. The metadata included in the codec agnostic container of the audio package may be independent of each of the audio codecs used to compress the multiple audio streams.

Digital Audio Workstations (DAWs) can allow automation of audio production where the DAW automatically performs tasks over time. The tasks can include, for example, changing automation data (e.g., equalizer, volume, sound location, and the like). Example implementations describe an audio package including automation data. The automation data can be decoupled from the audio codec using codec agnostic containers including the automation data. In other words, the automation data can be codec agnostic. The automation data can be represented in a block-based manner where a time interval of the block is decoupled from a time interval of the audio frame. The automation data block time interval can be smaller or larger than the audio frame time interval. Because the time interval of the automation data in the disclosed audio package can be decoupled from any of the audio streams, the automation data can be asynchronous. For example, the automation data does not require alignment at the frame boundaries. Example implementations can describe how the automation data value can vary arbitrarily over time according to curves defined by, for example, Bezier parameters.

Techniques enable streaming, seeking, and joining in order to determine an automation parameter value at any point in time, even if the value is not explicitly provided at that particular time. Example implementations can enable changing, modifying, and/or updating parameters including automation parameters.

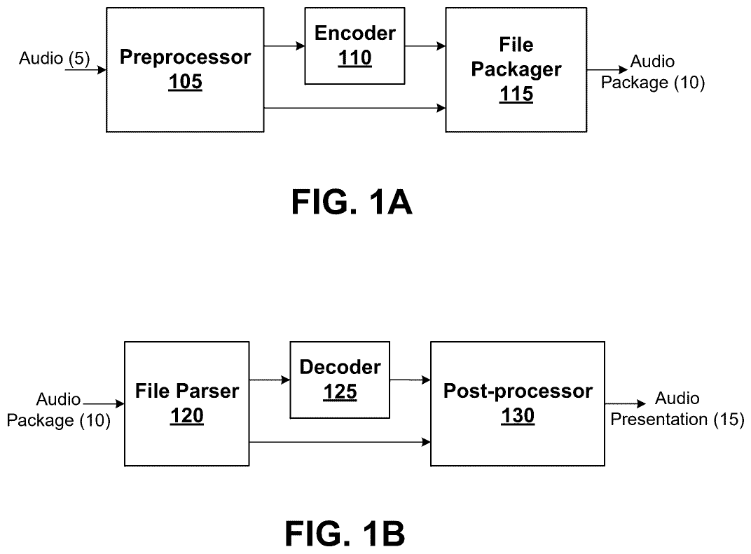

FIG. 1A illustrates a block diagram of a data flow for generating an audio package according to an example implementation. As shown in FIG. 1A, the data flow includes a preprocessor 105, an encoder 110, and a file packager 115. The flow of FIG. 1A is performed before audio is transmitted/streamed to a receiving device. The output of the flow of FIG. 1A, the audio package, can be stored, transmitted/streamed, stored before transmission/streaming, and/or the like.

Preprocessor 105 can be configured to take audio data 5 as input and generate a container(s) associated with the audio data 5. The container(s) can include at least one parameter. At least one parameter can be associated with compressing/decompressing the audio data 5. At least one parameter can be associated with other information (e.g., not associated with compressing/decompressing the audio data 5). At least one parameter can include metadata representing size, diffuseness, directivity, and/or the like. At least one parameter can include metadata that describes how to render audio channels and objects so that the audio channels and objects appear from the intended position in space, with the intended attributes (e.g., as a large diffuse sound source).

In an example implementation, the preprocessor 105 can be configured to generate a codec dependent (e.g., associated with compressing/decompressing the audio data 5) container and the preprocessor 105 can be configured to generate a codec agnostic container. For example, preprocessor 105 can be configured to generate a codec dependent container including parameters and data (e.g., values/variables for the parameters) associated with the codec used to compress/decompress the audio data 5. For example, preprocessor 105 can be configured to generate a codec agnostic container including parameters and data (e.g., values/variables for the parameters) including the abovementioned metadata associated with a presentation (e.g., playback) of the audio data 5. For example, the codec agnostic container can include parameters including time-varying data associated with playback of the audio data 5. Time-varying data can include any data associated with audio data 5 that can vary within/between audio frames within an audio package. For example, the codec agnostic container can include parameters including metadata that describes how to render audio channels and objects so that the audio channels and objects appear from the intended position in space, with the intended attributes (e.g., as a large diffuse sound source).

The audio data 5 can be recorded audio, stored audio, live audio, and the like. Audio data 5 can include audio data from one or more channels, one or more sources, and/or the like. For example, the audio data 5 can include audio data associated with at least two channels (e.g., left, and right channels or stereo). For example, the audio data 5 can include audio data associated with a plurality of channels (e.g., surround sound channels, ambisonics channels, and the like). The encoder 110 can be configured to compress the audio data 5. Encoder 110 can be configured to compress the audio data 5 using any codec (e.g., MPEG, Opus, a neural audio codec, AAC, and the like).

The file packager 115 can be configured to generate an audio package 10. The audio package 10 can include a header and a payload. The header can include information (e.g., parameters) and data (e.g., values/variables for the parameters) associated with the payload. The payload can include at least one container.

For example, the payload can include a codec dependent container(s) and/or a codec agnostic container(s). The payload can include at least one compressed audio data and/or a link(s) to (or references to) the respective compressed audio data. As mentioned above, the output of the flow of FIG. 1A, the audio package (10), can be streamed. Streaming can include generating a packet including at least one audio package (10), generating a bitstream including at least one audio packet, and transmitting/streaming the bitstream to at least one device configured to playback the audio data 5 (or reconstructed audio data 5) using the audio presentation.

In some implementations, the data flow of FIG. 1A can be used to generate an audio package that represents audio channels and objects using a unified, coordinate-based system. In this context, preprocessor 105 is configured to receive audio data 5 and its associated rendering information, which may originate from an authoring tool as described above. The preprocessor 105 then executes a translation process to generate the discrete, time-stamped metadata that describes how to render these channels or objects. This metadata, which specifies attributes like position, is then placed into a codec agnostic container. This process ensures creator intent is captured in an efficient format, independent of the audio codec.

For example, if the audio data 5 can include a dialogue track intended to emanate from a specific location, such as the upper-left corner of a room, the preprocessor 105 would generate metadata defining that position (e.g., azimuth and elevation coordinates). This positioning metadata, along with other potential attributes like diffuseness or size, would be included in the codec agnostic container. Meanwhile, the raw dialogue track itself is passed to encoder 110.

In some implementations, the preprocessor 105 may receive this rendering information directly from an audio authoring tool, such as a Digital Audio Workstation (DAW). Within the DAW, a sound designer creates automation lanes or curves to control the spatial position, gain, and other attributes of an audio track over time. The preprocessor 105 is configured to parse this project data, for example by reading a standardized interchange format like AAF or by interfacing directly with the DAW's API, to access the automation curves. It then translates these continuous curves into discrete, time-stamped metadata.

For example, the preprocessor may translate a Bézier curve from the DAW, which defines a smooth, continuous change in an object's position, by implementing an adaptive sampling algorithm. The sampling rate of the curve can be increased during periods of rapid change (e.g., high curvature or a large second derivative) and decreased when the curve is relatively flat or linear. A specific implementation of this algorithm may involve calculating the maximum deviation between the actual curve and a straight line segment connecting two sample points; if this deviation exceeds a predetermined error threshold, an intermediate sample point is recursively inserted at the point of maximum deviation. This process is repeated until the error for all segments is below the threshold. The resulting time-stamped sample points are then encoded as a sequence of values within a single parameter block, with the duration of the parameter block set to span the entire automation event. This effectively captures the creator's dynamic spatial intent from the authoring environment and encodes it into the bitstream as efficient, time-varying parameters with the minimum number of points required to represent the motion accurately.

Encoder 110 receives raw audio data 5 and compresses it using a selected audio codec (e.g., Opus). The parameters used by the decoder to correctly decompress this audio, such as the codec type and configuration, are packaged by the preprocessor 105 into a separate, codec-dependent container. This separation ensures that the rendering and positioning instructions (in the codec agnostic container) are independent of the audio compression format.

The file packager 115 then combines these components into the final audio package 10. It takes the compressed audio data from the encoder 110, the codec-dependent container 210, and the codec agnostic container from the preprocessor 105. It then assembles them into a structured format, generating the audio package 10 ready for storage or transmission. A single audio package can thus contain a mono audio stream (the dialogue) and the metadata used by a renderer to place it precisely in a 3D soundscape.

This process enables a unified representation for both channel-based and object-based audio. A traditional speaker channel, such as Left side surround (Lss), can be represented as a mono audio channel accompanied by metadata specifying its fixed position (e.g., azimuth+110°, elevation) 0°. Similarly, a dynamic audio object (e.g., a buzzing fly) would be a mono audio channel accompanied by time-varying metadata that changes its position over time. By handling both in this unified way, the system offers significant flexibility and efficiency.

FIG. 1B illustrates a block diagram of a data flow for generating an audio presentation according to an example implementation. As shown in FIG. 1B, the data flow includes a file parser 120, a decoder 125, and a post-processor 130. The flow of FIG. 1B is performed before audio is played back on a receiving device. The audio presentation 15 generated by the flow of FIG. 1B can be stored or played back by a computing device, e.g., a receiving device. The audio package 10 can be included in a streaming bitstream received by the computing device. The bitstream can include at least one audio packet and the at least one audio packet can include at least one audio package 10.

File parser 120 can be configured to receive an audio package 10 and parse the audio package 10 into a header and a payload. The file parser 120 can be further configured to parse the payload into audio data and at least one container. The audio data can include compressed audio data. At least one container can include a codec dependent container(s) and/or a codec agnostic container(s), each described below.

The decoder 125 can be configured to decompress audio data. For example, the decoder 125 can be configured to generate audio data by decompressing compressed audio data using an audio codec. The codec dependent container can include information associated with the audio codec. For example, the codec dependent container can include a parameter including the codec (e.g., used to compress the audio data). Therefore, decoder 125 can be configured to generate audio data by decompressing compressed audio data based on a parameter included in the codec dependent container.

The post-processor 130 can be configured to generate an audio presentation 15. The audio presentation 15 can be generated based on the codec agnostic container(s). The audio data (e.g., the decompressed or reconstructed audio data) can be played back based on (or using) the audio presentation 15. In some implementations, the post-processor 130 can be configured to generate an audio presentation 15 using parameters included in the codec dependent container. Therefore, in some implementations, the audio presentation 15 can be generated based on the codec agnostic container(s) and the codec dependent container.

In some implementations, post-processor 130 can use metadata to place the mono/stereo audio channel in space with the appropriate position and process the signal to apply other metadata. In the case of a speaker channel, the metadata can include speaker position information (and any additional information should be set so that no additional rendering processing is applied) and metadata representing size, diffuseness, directivity, and/or the like. The position information can be included as position parameters in the container (e.g., container 205 described below). Arbitrary speakers can include, for example, single speakers (e.g., Left (L), Right (R), Left side (Ls), and/or the like) and/or stereo pairs (e.g., L/R, Left side surround (Lss)/Right side surround (Rss), Left top front (Ltf)/Right top front (Rtf), Left top rear (Ltr)/Right top rear (Rtr) and/or the like). The position information and/or position parameters can include azimuth and elevation of the associated speaker.

In some implementations, the data flow of FIG. 1B for generating an audio presentation on a playback device can represent the reverse process of FIG. 1A. The data flow begins when a receiving device obtains audio package 10, for example, via streaming or from local storage. File parser 120 can read audio package 10 and separates its constituent parts. File parser 120 can identify the compressed audio data, the codec-dependent container including decompression parameters, and the codec agnostic container holding the rendering and positioning metadata.

The compressed audio data and the codec-dependent container are sent to the decoder 125. The decoder 125 uses the information from the codec-dependent container, such as the codec type (e.g., Opus) and its specific configuration, to decompress the audio data. The output is a raw, decompressed audio stream (e.g., the mono dialogue track from above). This stream represents the audio content, separate from any instructions on how it should be presented in a 3D space.

Further, the codec agnostic container is passed to the post-processor 130. The post-processor 130, often referred to as a renderer, interprets the metadata within this container to understand the creator's intent for the final audio scene. This metadata includes positioning information (e.g., azimuth, elevation), size, diffuseness, and any other attributes that define how the audio should be placed and perceived within the listening environment.

The post-processor 130 then takes the decompressed audio stream from the decoder 125 and applies the rendering instructions from the codec agnostic metadata. For the dialogue track intended for the upper-left corner, the post-processor 130 would use rendering algorithms (e.g., panning, virtualization) to place the audio at the specified coordinates. This process can be repeated for all audio channels and objects defined in the audio package, mixing them into a final, cohesive soundscape.

The final output is audio presentation 15, a multi-channel audio signal tailored to the specific speaker layout of the playback device (e.g., headphones, a 5.1 surround system, a soundbar, and the like). This signal is then sent to the device's speakers to reproduce the immersive audio experience as intended by the content creator. By separating the codec-dependent decoding from the codec agnostic rendering, this data flow ensures maximum flexibility and compatibility across different devices and audio formats.

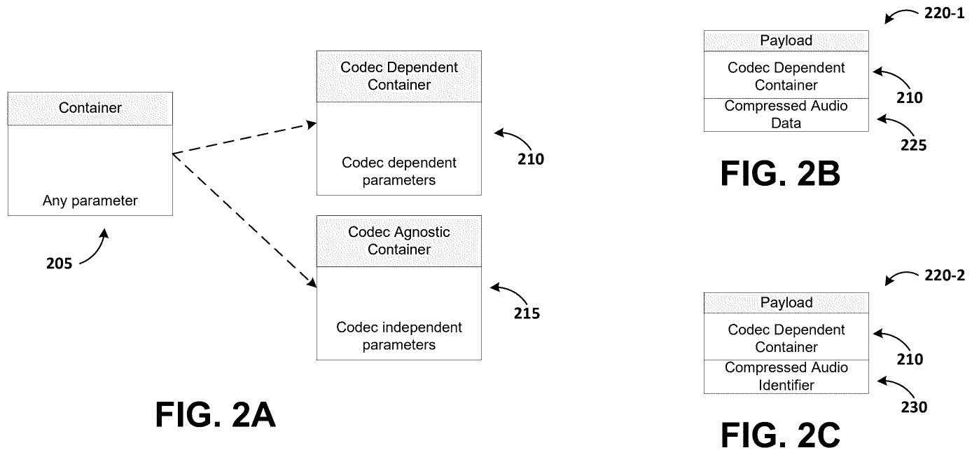

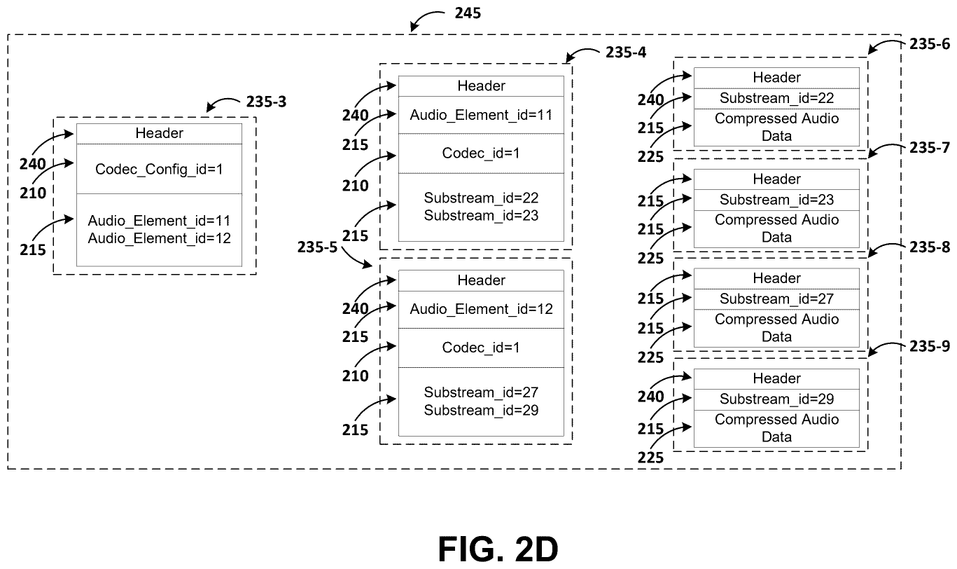

FIG. 2A illustrates a block diagram of containers according to an example implementation. In this example, a container 205 can include at least one parameter. The at least one parameter included in the container 205 can be any parameter associated with information of any kind having any audio role. In an example implementation, parameters can be in different containers based on a role of the parameter. For example, as shown in FIG. 2A, the parameters can be in a codec dependent container 210 and a codec agnostic container 215. The codec dependent container 210 can include at least one parameter that has a role related to compression and/or decompression of audio data. For example, the codec dependent container 210 can include a parameter that includes the codec (e.g., MPEG, Opus, a neural audio codec, AAC, and the like) used by, for example, encoder 110 to compress, for example, audio data 5.

Codec agnostic container 215 can include at least one parameter that has a role unrelated to compression and/or decompression of audio data. For example, the codec agnostic container 215 can include a parameter that includes a loudness (e.g., volume) of the audio data used during playback of the audio data. The codec agnostic container 215 can include metadata representing size, diffuseness, directivity, and/or the like. The codec agnostic container 215 can include metadata that can be referred to as mix presentation. The codec agnostic container 215 can include metadata that relates to mono (single) and stereo (pair) audio data (e.g., signals, channels) into a 3D audio stream. For example, the metadata that relates to mono (single) and stereo (pair) audio signals (e.g., channels) can be in a codec dependent container 210. Accordingly, the codec agnostic container 215 can include metadata associated with mono (single) and stereo (pair) audio signals (e.g., channels).

In an example implementation, the codec agnostic container 215 can include information associated with two or more audio streams and each of the audio streams can have an associated loudness parameter with a respective same or different value. For example, the codec agnostic container 215 can include parameters including time-varying data associated with playback of the audio data 5. Time-varying data can include any data associated with the audio data 5 (e.g., mono audio data and/or stereo audio data) that can vary within/between audio frames.

FIG. 2A can illustrate how different types of audio information can be separated into containers based on their role. The division shown is between the codec-dependent container 210 and the codec agnostic container 215. The codec-dependent container 210 is for parameters that are coupled to the audio compression format itself. For example, if the audio is encoded using the Opus codec, this container would hold information such as the Opus-specific configuration required by the decoder to properly reconstruct the audio signal. The codec-dependent container 210 can isolate the details of the audio compression from all other aspects of the audio presentation.

The codec agnostic container 215, in contrast, holds parameters related to how the audio should be rendered and presented to the listener, irrespective of the codec used for compression. The codec agnostic container 215 can include the creative intent of the audio producer. Information such as the three-dimensional positioning of an audio object (e.g., its azimuth and elevation), its perceived size, or its diffuseness is included here. Because these parameters are independent of the audio codec, the underlying compressed audio could be transcoded from Opus to AAC, for example, without needing to alter or re-time the rendering metadata in the codec agnostic container.

This separation provides flexibility. An audio package can be manipulated in various ways without requiring a full decode and re-encode of the audio. For example, different language tracks, each with its own compressed audio data 225 and codec-dependent container 210, could share a single codec agnostic container 215 that describes the spatial positioning for sound effects. A streaming service could then dynamically switch language tracks by swapping out the relevant codec-dependent components while keeping the shared, codec agnostic rendering instructions.

Furthermore, this architecture can allow for different mix presentations within a single audio package. A single compressed audio stream (e.g., a dialogue track) could be referenced by multiple codec agnostic containers, each describing a different rendering scenario. For example, one codec agnostic container could place the dialogue centrally for a standard presentation, while another could position it closer to the listener for a near-field mix intended for headphones. This can be achieved efficiently, as the core audio data is stored only once.

For example, an audio package for a film scene can feature a helicopter. The raw audio of the helicopter sound effect can be compressed (e.g., with Opus) and stored as compressed audio data 225. The parameters for Opus decoding would go into codec-dependent container 210. The time-varying metadata describing the helicopter's flight path across the soundscape, for example, its changing azimuth, elevation, and volume can be placed in the codec agnostic container 215. A playback device can use container 210 to decompress the helicopter sound and container 215 to render its movement, ensuring a consistent spatial experience regardless of the underlying audio codec.

FIGS. 2B and 2C illustrate block diagrams of a payload according to an example implementation. As shown in FIG. 2B, a payload 220-1 can include a codec dependent container 210 and a compressed audio data 225. As shown in FIG. 2C, a payload 220-2 can include a codec dependent container 210 and a compressed audio identifier 230. In an example implementation, a compressed audio identifier 230 can be a link(s) to (or reference(s) to) a compressed audio data 225.

FIG. 2B builds upon this concept by illustrating a specific payload structure within an audio package. For example, the payload 220-1 can include both the codec-dependent container 210 and the compressed audio data 225. This arrangement can be used for simple, self-contained audio elements where the audio data and its corresponding decompression instructions are packaged together. This payload represents a building block of an audio stream.

For example, a single audio package can include a payload like the one in FIG. 2B for each discrete sound. If a scene includes dialogue and background music as separate audio elements, one payload can include the compressed dialogue track and its Opus codec parameters (in container 210), while a second, separate payload can include the compressed music track and its corresponding AAC codec parameters. The rendering instructions for positioning this dialogue and music can be included in a codec agnostic container elsewhere in the audio package.

This structure can allow for granular access to audio data. A playback system can parse an audio package and directly access the compressed audio data 225 for a specific sound effect without needing to process unrelated data. The codec-dependent container 210 can provide the information for the decoder to handle that specific chunk of compressed data, ensuring data is decompressed correctly.

This direct inclusion model is particularly useful in scenarios where simplicity and data locality are prioritized. For file-based playback or simple streaming applications, bundling the compressed audio data 225 with its codec-dependent container 210 reduces parsing complexity. The system can treat each payload as an independent unit, passing it directly to the appropriate decoder without having to resolve external references to the audio data.

By contrast, FIG. 2C (described below) illustrates an alternative payload structure where the compressed audio data is referenced rather than included directly. The structure in FIG. 2B is more straightforward and can be used when audio data is not shared or reused across different parts of the bitstream. The payload in FIG. 2B can ensure that everything needed to decode a particular segment of audio is located within a single payload unit.

FIG. 2C shows an alternative payload structure that introduces greater efficiency and flexibility, particularly in complex audio packages where audio data may be reused. In this model, the payload 220-2 can include the codec-dependent container 210 and a compressed audio identifier 230. Instead of embedding the compressed audio data 225 directly within the payload, this identifier 230 can act as a reference or a link to the location of the compressed audio data elsewhere in the bitstream or audio package.

This indirect reference mechanism can enable bit-rate savings and efficient stream management. When the same audio content (e.g., a specific sound effect or a segment of ambient noise) is used multiple times within a presentation or across different mix presentations, audio content only needs to be stored once. Multiple payloads can then point to this single instance of compressed audio data 225 using their respective compressed audio identifiers 230, avoiding data duplication and reducing the overall file size.

For example, a scene can include intermittent rainfall. The audio data for the rain sound effect can be stored once. Each time the rain sound is needed, payload 220-2 can be used. In this example, payload 220-2 can include the codec-dependent container 210 for decoding and an identifier 230 that points to the rain sound's compressed data. This approach can allow the audio content to be decoupled from the content usage context. This can simplify scenarios like remixing or dynamically creating different audio experiences from the same set of source materials.

This structure can also facilitate more complex bitstream manipulations. For example, in an adaptive streaming scenario, different quality levels of an audio track can be stored. Payloads can then reference the appropriate quality level based on network conditions, without altering the higher-level structure of the audio package. The compressed audio identifier 230 can provide the data used to locate the correct audio data chunk, making the system more modular and adaptable.

The choice between the direct inclusion model of FIG. 2B and the indirect reference model of FIG. 2C can depend on the specific use case. Payload 220-1 of FIG. 2B can offer simplicity and can be used for self-contained audio elements. By contrast, payload 220-2 of FIG. 2C can provide more efficiency for larger, more complex audio packages that require data reuse and greater flexibility in referencing and/or linking audio content.

The payload structures of FIGS. 2A-2C, whether using direct inclusion or indirect referencing and/or linking, serve as the foundational building blocks for the audio data itself. To construct a complete, multi-element audio scene, however, a higher-level framework can be required to orchestrate these payloads alongside the codec agnostic containers that hold the rendering metadata. This framework can use a system of identifiers to link the structural definition of the audio scene to the specific codec configurations to the individual compressed audio substreams.

FIG. 2D illustrates another block diagram of a packet according to an example implementation. FIG. 2D illustrates how the previously described packages can be linked together within a single packet 245 to form a hierarchical structure representing a complex audio scene. This example shows how identifiers are used to link a high-level scene description to specific codec configurations and their corresponding compressed audio data substreams. As mentioned above, a packet 245 can include at least one package (e.g., package 235-4). Therefore, a packet 245 can include a portion (e.g., a stream, a substream, a channel, and the like) of the information and data associated with the playback of audio.

In the example implementation illustrated in FIG. 2D, the packet 245 includes package 235-3, 235-4, 235-5, 235-6, 235-7, 235-8, 235-9. The package 235-3 includes a header 240 including information associated with a payload including a codec dependent container 210 and a codec agnostic container 215. The codec dependent container 210 of the package 235-3 includes a codec configuration (codec_config) identification (id) parameter with a value set to one (1). The codec agnostic container 215 of the package 235-3 includes audio element (audio_element) identification (id) parameters with values of 11 and 12. The parameter codec_config_id can be used to indicate that audio_element_id=11 and audio_element_id=12 were coded using codec_config_id=1. The parameters audio_element_id=11 and 12 and the parameter codec_config_id=1 can be links or references to other packages.

The package 235-4 includes a header 240 including information associated with a payload including a codec dependent container 210 and two codec agnostic containers 215. The codec dependent container 210 of the package 235-4 includes a codec (codec) identification (id) parameter with a value set to one (1). One of the codec agnostic containers 215 of the package 235-4 includes audio element (audio_element) identification (id) parameters with a value of 11. The audio element (audio_element) identification (id) parameters with a value of 11 can be a link between the package 235-3 and the package 235-4, where audio_element_id=11 of package 235-3 operates as a link to package 235-4. The other codec agnostic containers 215 of the package 235-4 includes substream identification (id) parameters with values of 22 and 23. The parameter codec can be used to indicate that audio_element_id=11 was coded using codec=1 (e.g., MPEG, Opus, a neural audio codec, AAC, and the like). The parameters substream_id=22 and 23 and the parameter codec_id=1 can be links or references to other packages.

The package 235-5 includes a header 240 including information associated with a payload including a codec dependent container 210 and two codec agnostic containers 215. The codec dependent container 210 of the package 235-5 includes a codec (codec) identification (id) parameter with a value set to one (1). One of the codec agnostic containers 215 of the package 235-5 includes audio element (audio_element) identification (id) parameters with a value of 12. The audio element (audio_element) identification (id) parameters with a value of 12 can be a link between the package 235-3 and the package 235-5, where audio_element_id=12 of package 235-3 operates as a link to package 235-5. The other codec agnostic containers 215 of the package 235-5 includes substream identification (id) parameters with values of 27 and 29. The parameter codec can be used to indicate that audio_element_id=12 was coded using codec=1 (e.g., MPEG, Opus, a neural audio codec, AAC, and the like). The parameters substream_id=27 and 29 and the parameter codec_id=1 can be links or references to other packages.

The package 235-6 includes a header 240 including information associated with a payload including a codec dependent container 210 and compressed audio data 225. The substream identification (id) parameter with a value of 22 can be a link between the package 235-4 and the package 235-6, where substream_id=22 of package 235-4 operates as a link to package 235-6. The package 235-7 includes a header 240 including information associated with a payload including a codec dependent container 210 and compressed audio data 225. The substream identification (id) parameter with a value of 23 can be a link between the package 235-4 and the package 235-7, where substream_id=22 of package 235-4 operates as a link to package 235-7.

The package 235-8 includes a header 240 including information associated with a payload including a codec dependent container 210 and compressed audio data 225. The substream identification (id) parameter with a value of 27 can be a link between the package 235-5 and the package 235-8, where substream_id=27 of package 235-5 operates as a link to package 235-8. The package 235-9 includes a header 240 including information associated with a payload including a codec dependent container 210 and compressed audio data 225. The substream identification (id) parameter with a value of 29 can be a link between the package 235-5 and the package 235-9, where substream_id=29 of package 235-5 operates as a link to package 235-9. The compressed audio data 225 of package 235-6, package 235-7, package 235-8, and package 235-9 can include the audio data associated with package 235-3.

FIG. 2D illustrates a complete, high-level view of how different packages can be structured and linked within a single packet 245 to create a complex audio presentation. FIG. 2D illustrates an implementation referencing and data-sharing capabilities enabled by the separation of codec-dependent and codec agnostic containers, as well as the use of identifiers.

The structure shown in FIG. 2D represents a hierarchical system. At the top level, packet 245 can include multiple individual packages (235-3 through 235-9). Each package serves a specific role, either defining the structure of the audio scene, specifying codec parameters, or carrying the actual compressed audio data. This modularity allows for efficient representation and flexible manipulation of the audio content.

Package 235-3 can act as a high-level descriptor or a manifest for a part of the audio presentation. Header 240 can include general information about this segment. The payload can include both a codec-dependent container 210 and a codec agnostic container 215. The codec-dependent container 210 can specify a codec_config_id with, for example, a value of 1, establishing a reference to a particular codec configuration.

The codec agnostic container 215 in package 235-3 can define the structural layout of the audio scene by referencing and/or linking two distinct audio elements, identified by audio_element_id values of 11 and 12. These audio elements can represent, for example, a dialogue track and a background music track. This package can declare that the audio presentation is composed of these two elements and that they share the codec configuration identified by codec_config_id=1.

The packet 245 can include package 235-4 and package 235-5, which further define these audio elements. Package 235-4 can be linked to the first audio element through its audio_element_id value of 11. Package 235-4 can include its own codec-dependent and codec agnostic containers. The codec-dependent container 210 can link to a specific codec (codec_id=1), which can be, for example, the Opus codec.

The codec agnostic container 215 within package 235-4 then breaks down audio_element_id=11 into its constituent audio substreams, identified by substream_id values 22 and 23. This can represent a stereo pair for the dialogue track, where substream 22 is the left channel and substream 23 is the right channel. Any rendering metadata specific to this dialogue element (e.g., a static position in the sound field) can further be included here.

Similarly, package 235-5 can define the second audio element, audio_element_id=12. Package 235-5 can include a codec-dependent container 210 that also points to codec_id=1, indicating that the background music track is also encoded with Opus. Package 235-5 can include a codec agnostic container 215 that identifies the substreams for this element, in this case substream_id values 27 and 29. These could represent the left and right channels of the stereo background music.

This structure demonstrates efficiency. Both the dialogue and music elements share the same codec (codec_id=1), a common scenario. This information is declared at the element level, avoiding redundant signaling for each individual substream. Different elements could, however, reference different codec IDs if they were encoded with different codecs.

Finally, the packet 245 can include the packages that hold the actual compressed audio data: packages 235-6, 235-7, 235-8, and 235-9. These packages follow the direct-inclusion payload structure shown in FIG. 2B. Each one is linked to a specific substream ID defined in the higher-level packages.

For example, package 235-6 is identified by substream_id=22 and includes the compressed audio data 225 for the left dialogue channel. Likewise, package 235-7 (substream_id=23) includes the data for the right dialogue channel. Packages 235-8 (substream_id=27) and 235-9 (substream_id=29) include the audio data for the left and right background music channels, respectively.

This layered referencing and/or linking system can be highly flexible. A playback device parsing packet 245 can start at the top-level package (235-3), identify the audio elements (11 and 12), then follow the references to their definitions (in 235-4 and 235-5) to find the constituent substream IDs (22, 23, 27, 29). The playback device can then locate the corresponding packages including the compressed audio data for each substream.

FIG. 2D can illustrate a packet architecture that effectively decouples the audio scene's structure (in codec agnostic containers) from codec-specific information (in codec-dependent containers) and the raw compressed data. Through a hierarchical system of identifiers (codec_config_id, audio_element_id, substream_id), it creates a highly organized, efficient, and flexible format for representing complex, multi-element immersive audio presentations.

To clarify the interplay between the identifiers, codec_id and codec_config_id serve distinct roles in this hierarchy. The codec_id is a fundamental value that specifies the type of audio codec being used (e.g., a value of ‘l’ might correspond to the Opus codec). It is not a reference to another package. In contrast, codec_config_id is a higher-level identifier that acts as a reference to a complete set of configuration parameters for a codec. This is why it is used in the top-level package 235-3; it groups audio_element_id=11 and audio_element_id=12 under a single shared configuration (‘1’) without needing to specify all the details of that configuration at the top level. The subsequent packages, 235-4 and 235-5, then provide the specific details for that configuration as it applies to their respective audio elements, including the fundamental codec_id=1. This allows a single, potentially complex codec configuration (e.g., which might include parameters for bitrate, sample rate, and other decoder settings beyond just the codec type) to be defined once and referenced by multiple audio elements, promoting efficiency and modularity.

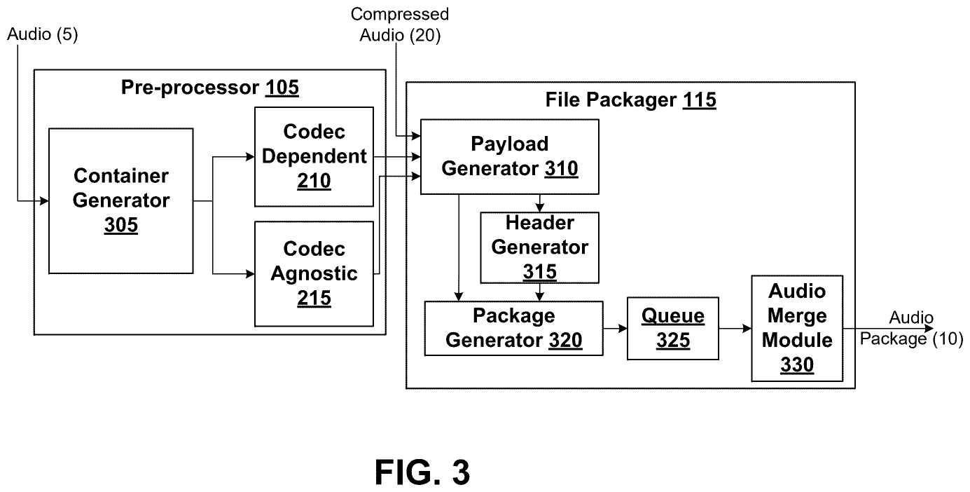

FIG. 3 illustrates a block diagram of a data flow for generating an audio package according to an example implementation. As shown in FIG. 3, the data flow includes the preprocessor 105 and the file packager 115. The preprocessor 105 includes a container generator 305 block, a codec dependent container 210 block, and a codec agnostic container 215 block. The file packager 115 includes a payload generator 310 block, a header generator 315 block, a package generator 320 block, a queue 325 block, and an audio merge module 330 block. The container generator 305 is configured to generate the codec dependent container 210 and the codec agnostic container 215 (each described above).

Example implementations include containers (e.g., the codec dependent container 210 and the codec agnostic container 215) used to decouple the physical speaker layouts from the mixing and content creation. For example, a container can include parameters as a description of the sound, which can then be reproduced on any physical speaker layout. In an example implementation, the codec agnostic container 215 can include parameters representing audio production choices (e.g., choices made by a mix engineer). The parameters can be modified during playback. For example, object panning or location automation, gain controls and DRC controls, and some degree of EQ, delay, and reverb effects that are part of spatial rendering can be changed during playback by updating (or modifying) a value associated with the relevant parameter (or parameter value).

Sometimes parameters and data (e.g., values/variables associated with the parameters) can be referred to as metadata. In some implementations, the metadata can represent (or include data associated with) audio channels corresponding to arbitrary speakers and/or audio objects that can be placed anywhere in space with metadata representing size, diffuseness, directivity, and/or the like. The position information can be included as position parameters in the container (e.g., container 205). Arbitrary speakers can include, for example, single speakers (e.g., Left (L), Right (R), Left side (Ls), and/or the like) and/or stereo pairs (e.g., L/R, Left side surround (Lss)/Right side surround (Rss), Left top front (Ltf)/Right top front (Rtf), Left top rear (Ltr)/Right top rear (Rtr) and/or the like). The position information and/or position parameters can include azimuth and elevation of the associated speaker. In some implementations, a symmetry axis parameter (e.g., default_azimuth_symmetry_axis) can be included to set an azimuth along which stereo pairs are mirrored. This allows for greater flexibility in the locations of stereo pairs, permitting them to be mirrored around an axis other than the front-center (azimuth=0).

FIG. 3 illustrates the interactions between the preprocessor 105 and the file packager 115. File packager 115 can be configured to generate an audio package 10 based on information received from preprocessor 105. FIG. 3 can illustrate the role of several components within the file packager 115.

The data flow begins within the preprocessor 105, where the container generator 305 can be tasked with creating the metadata containers. Based on the input audio and the creator's intent, the container generator 305 can be configured to generate both the codec dependent container 210, including codec-specific decoding parameters, and the codec agnostic container 215, including rendering and positioning metadata. These containers encapsulate the information used for subsequent stages of packaging and playback.

Once generated, codec dependent container 210 and codec agnostic container 215 can be passed to the file packager 115. The file packager 115 includes payload generator 310 configured to assemble the payload of an individual package. The payload generator 310 can be configured to combine the codec dependent container 210, the codec agnostic container 215, and the associated compressed audio data (or a reference to it) into a coherent payload unit.

The file packager 115 further includes header generator 315 configured to construct the header 240 for the package 235. This header 240 can include identifying information, such as the package type, length, and any identifiers that link this package to other components within the bitstream, for example, a substream_id or audio_element_id. The header provides structural information for a parser to navigate the audio package 10 correctly.

The package generator 320 takes the outputs from the header generator 315 and the payload generator 310 to form a complete, well-structured package. This package represents a building block of the audio presentation, such as a single frame of a mono audio channel with its associated decoding and rendering metadata.

Some implementations include generating an audio package with multiple audio streams, each generated package can be temporarily held in the queue 325. Queue 325 can be configured to operate as a buffer, organizing the various packages that constitute a complete audio scene. For example, packages for a dialogue substream, a music substream, and a sound effects substream might be generated sequentially and placed into queue 325.

This queuing mechanism can be configured to manage complex audio presentations that involve multiple, potentially asynchronous, audio elements. Queue 325 can ensure that components are ready before the final assembly step, supporting the flexible and modular nature of the architecture. Queue 325 can allow the system to process streams with different frame rates or timing offsets.

Finally, the audio merge module 330 retrieves the organized packages from the queue 325 and assembles them into the final audio package 10. Merge module 330 can be responsible for interleaving and arranging the individual packages according to the defined structure of the bitstream, ensuring that all references and links between packages are correctly resolved. The output is a single, cohesive audio package 10 ready for transmission or storage.

An example of this flow can be a 5.1 channel audio presentation. The preprocessor 105 can generate six separate codec dependent and codec agnostic containers, one for each of the six audio channels (L, R, C, LFE, Ls, Rs). The payload generator 310 and header generator 315 can together generate six distinct packages, each including compressed audio for one channel along with its metadata.

These six packages can be placed in queue 325. The audio merge module 330 would then pull these packages from queue 325 and possibly a higher-level structural package (e.g., package 235-3 from FIG. 2D) that defines the 5.1 layout. The module 330 would then assemble them into a single audio package 10, correctly ordered and structured for playback.

In some implementations preprocessor 105 can be configured to generate a codec agnostic container 215 with rendering metadata. The file packager 115, in turn, can include a package generator 320 configured to generate packages from the container and a queue 325 to store these packages before an audio merge module 330 combines them into a final multi-stream audio package 10.

Furthermore, the architecture can allow for efficient handling of different mix presentations. For example, a creator can include both a wide stereo mix and a narrow stereo mix of a music track. The same compressed audio substreams can be used for both. The container generator 305 creates two different codec agnostic containers 215, each with different positioning metadata.

The package generator 320 creates two sets of packages referencing and/or linking the same audio data but including the different codec agnostic containers. These are placed in queue 325. The audio merge module 330 then assembles them into an audio package 10 that can include both mix presentations, allowing a user to select between them at playback time without data duplication. This method directly supports a claim related to referencing and/or linking the same audio substream from multiple mix presentations.

In some implementations, the codec agnostic container 215 can include parameters for arbitrary speaker positions, such as specifying a dialogue channel to emanate from a position of azimuth+45° and elevation+30° (Ltf position). The container generator 305 can be configured to generate the codec agnostic container 215 with this positioning metadata. The file packager 115 then packages this container with the compressed dialogue audio, resulting in an audio package that precisely defines this spatial intent. In some implementations, the loudspeaker layout can be extended to include standalone Low Frequency Effects (LFE) channels which may not have an associated position, or channels such as Top-Center (T+000) which has an elevation (e.g., +90 degrees) but no azimuth and therefore cannot be signaled via standard azimuth/elevation position parameters.

In some implementations, the data flow illustrated in FIG. 3 can support time-varying metadata. For example, if an audio object is meant to move across the soundscape, the container generator 305 can generate a series of codec agnostic containers 215, or a single container with a parameter block describing the motion curve over time. The file packager 115 then assembles these into a sequence of packages that a renderer can interpret to create the dynamic effect.

In some implementations, two substreams can have different audio frame durations, and the preprocessor 105 and file packager 115 can handle them independently. The package generator 320 can generate packages for each stream according to their respective timings. The queue 325 buffers these packages, and the audio merge module 330 interleaves them into a single bitstream. Synchronization is achieved by including absolute presentation timestamps (e.g., in microseconds, relative to an identified timeline) within the header of each audio frame package and parameter block. This allows the renderer, upon parsing the bitstream, to place all components onto a unified timeline for correct playback, ensuring proper synchronization of audio and metadata without needing to align frame boundaries at the container level. In some implementations, synchronization can include signaling a seek point within a bitstream that includes an audio package. The seek point can enable playback to begin without reference to preceding data.

For example, a main audio stream can be encoded with Opus at 20 ms frames, while a secondary stream with sound effects can be encoded with AAC at 21.33 ms frames. The container generator 305 can generate containers for each. The package generator 320 can generate packages aligned to their respective frame boundaries. The audio merge module 330 combines them, and the resulting audio package 10 can include two asynchronous substreams that can be merged seamlessly by a capable playback device.

Rendering algorithms can be configured to map a virtual space to a listener's physical audio system. Physical systems can be, for example, multi-channel home theaters, sound bars, stereo, earbuds, and/or portable speakers (which may often be mono). Example implementations include techniques for rendering depending on physical speaker layouts. For example, a codec agnostic container 215 can include parameters for direct mapping the audio channels to physical speakers, downmix and panning methods (e.g., mapping audio channels to multiple physical channels, gain weighted), soundbar rendering spatialization techniques for sound like surround sound setup with only one bar of speakers at the front of the room, and/or head tracked binaural spatialization techniques.

Example implementations include techniques that indicate loudness information of two or more audio streams within a bitstream (e.g., a merged bitstream). For example, a codec agnostic container 215 can include parameters to describe multiple sets of loudness information, each associated with a sub-mix of audio substreams. To enable consistent playback levels, these parameters can include integrated loudness values measured according to a standard like ITU-R BS.1770-4 (LUFS), along with a target loudness level for the final mix (e.g., −23 LUFS). The container can then include instructions, such as specific gain parameters, that the renderer should apply to each sub-mix to achieve the target level. For example, if a dialogue sub-mix has a measured integrated loudness of −20 LUFS, the container would signal a gain adjustment of −3 dB to normalize it to the −23 LUFS target before it is summed with other sub-mixes. The relative gain of each submix contributing to the final mix can also be adjusted using separate gain parameters that are set during content creation and/or during playback. The parameters described below can be included in a codec agnostic container 215 to implement the above techniques.

The codec dependent container 210 can include codec dependent information about the audio data and/or audio playback. The codec dependent container 210 can include parameters representing a codec configuration identification, a codec identification, a decoder configuration identification, a number of samples per frame, a roll distance, a number of audio elements (e.g., audio channels, audio streams, audio substreams and/or the like), and an audio element identification. The audio element identification parameter can be used to link a higher-level package defining a scene structure to a lower-level package that defines the audio element itself. The codec configuration identification can indicate a unique ID in a bitstream for a given codec configuration.

The codec identification can be a code to identify the codec used to generate the audio substreams. The decoder configuration can specify a set of codec parameters to decode an audio substream for the given codec identification. The number of samples per frame can indicate the frame length, in samples, of the raw coded audio. In an example implementation the audio data 5 includes two or more substreams and a first substream can have a first frame length and the second substream can have a second frame length. The first frame length can be different than the second frame length. The roll distance can be a signed integer that gives the number of frames to be decoded in order for a frame to be decoded correctly. The number of audio elements can specify the number of audio elements that refer to the codec configuration. The audio element identification can specify the unique ID associated with the specific audio element that refers to the codec configuration. In some implementations, the codec dependent container can also include a substream identification parameter to directly link a specific codec configuration to a package containing the corresponding compressed audio data. The codec dependent container 210 can include other information not discussed above. However, additional information included in a codec dependent container 210 may be discussed below.

A codec agnostic container 215 can include a parameter block(s). The parameter block(s) can include a parameter identification, a duration, a number of segments, a constant segment interval, a parameter definition type, arbitrary speakers and/or audio objects that can be placed anywhere in space with metadata representing size, diffuseness, directivity, and/or the like. The parameter identification can indicate a unique identification that is associated with a specific parameter definition. A parameter definition can refer to, for example animation, gain, demixing, and the like. The duration can specify the duration for which the parameter block is valid and applicable. The number of segments can specify the number of different sets of parameter values specified in the parameter block, where each set describes a different segment of the timeline, contiguously. The constant segment interval can specify the interval of each segment, in the case where all segments have equal intervals. There can be a run-time function configured to map the parameter identification to a registered parameter definition type. The parameter block(s) can include other data not discussed above. However, additional parameter block(s) may be discussed below.

A codec agnostic container 215 can include an audio frame(s) or a reference to an audio frame(s). For example, parameters representing an audio frame can include a substream identification, a coded frame size, an audio frame, and the like. The substream identification can indicate a unique identification in a bitstream for a given substream. The coded (e.g., compressed) frame size can be the size of the audio frame in bytes. The audio frame can be the compressed audio data for the frame or a reference to the compressed audio data for the frame.

A codec agnostic container 215 can include a synchronization parameter(s). A synchronization parameter establishes a reference point in the timeline, enabling a decoder to begin playback at a specific seek point without reference to preceding data. A data unit that contains one or more synchronization parameters to signal such a seek point is referred to as a keyframe. A keyframe is a self-contained data unit that provides a clean entry point into the bitstream, typically by containing synchronization parameters that signal a re-initialization of the renderer's state and a full snapshot of all active parameter values. This allows playback to begin immediately from the keyframe's position without knowledge of any preceding data, facilitating random access and robust streaming.

The relative offset can describe the position of audio and parameters in a local frame of reference. The concatenation rule can specify a type of concatenation rule that is applied to position the audio frames and parameters that happened after a synchronization block with respect to the timeline before the synchronization block. In some implementations, synchronization can include signaling a seek point within a bitstream that includes an audio package. The seek point can enable playback to begin without reference to preceding data.

In some implementations, a data unit that signals such a seek point and establishes a complete, self-contained state for the renderer is referred to as a keyframe. A keyframe contains synchronization parameters, and when configured to re-initialize the decoder and provide a full set of active parameter values, it allows for random access into the bitstream.

In some implementations, synchronization parameters. For example, a synchronization parameter can be generated to explicitly signal a clean seek point. This synchronization parameter can be configured to function as a marker within the bitstream, enabling a playback device to begin rendering audio and metadata from that point without any knowledge of preceding data. For example, when a user skips to the middle of a track, the player locates the nearest preceding synchronization parameter to initialize the decoder and renderer, ensuring immediate and glitch-free playback.

In some implementations, this flexibility can be extended by allowing keyframes (data units containing synchronization parameters) to have variable sizes. A keyframe's payload includes metadata that can be defined with a specific duration. This duration is decoupled from the audio frame rate and can be set to span a variable number of audio frames. For example, a keyframe can explicitly signal that a subsequent parameter block has a duration of 50 audio frames. During a dynamic audio scene with rapid changes, a first keyframe can be generated with a metadata payload defined to have a short duration, perhaps spanning only two audio frames. By contrast, for a long, static scene, a second keyframe could be generated with a metadata payload defined to apply across hundreds of audio frames, significantly improving bitrate efficiency. This ability to generate keyframes whose effective duration and thus size can vary within the same bitstream provides a highly adaptive signaling mechanism.

Some implementations can include generating intentional gaps in the timeline of parameter blocks to improve efficiency. For example, after an initial parameter block is sent, if the metadata value it describes does not change for a subsequent period, no further parameter blocks for that metadata stream need to be sent. During this gap, a renderer can be configured to behave in a defined manner. In some implementations, the renderer can continue using the last known value from the preceding block, thus avoiding redundant data transmission for static parameters. This behavior can be referred to as a hold state.

In a related efficiency measure, the system can provide a distinct mechanism to explicitly signal the absence of a parameter value for a given time interval, which instructs the renderer to behave differently than in a hold state. Instead of continuing to use the last known value, the renderer can be instructed to revert to a predefined default value specified in the parameter's definition. This is signaled, for example, by transmitting a parameter block that contains a duration but whose value payload is explicitly empty or null. A parser can distinguish this from simple omission (e.g., the hold state) and can interpret the presence of the block with an empty payload not as an error, but as an explicit instruction to apply the default value for the specified duration. For example, if a sound object moves to a specific position and then becomes inactive, this mechanism can signal its inactivity, causing the renderer to use a default gain of zero (silence) as specified in the parameter's definition, until a new parameter block is signaled.

To facilitate parsing, some implementations can include a synchronization parameter used to signal these synchronization points, differentiating it from other data units that carry audio frames or the parameter blocks themselves. By creating a unique identifier for this function, a decoder can quickly scan a bitstream for seek points without needing to parse the full content of every data block, streamlining seeking and stream joining operations.

The role of the keyframe and its synchronization parameters in seeking can be important. When generated, a keyframe can define precisely which parameter blocks are present and active at the seek point, allowing a renderer to establish a complete and accurate initial state. For example, upon seeking, the keyframe's payload can carry a full snapshot of the rendering state, structured as a list of (parameter_ID, value) tuples for every active parameter. This payload can initialize rendering values (e.g., object position, size, and gain), ensuring that the audio presentation starts as the creator intended from that moment without requiring any preceding data.

For example, should a user initiating a seek to a specific time within a media file, the playback device's file parser 120 can scan the bitstream backward from the target seek time to locate the nearest preceding synchronization parameter, which is contained within a keyframe. Upon finding the keyframe, the parser uses the information within, such as the reinitialize_decoder flag, to reset the state of the decoder 125. Simultaneously (and/or substantially simultaneously), the post-processor 130 can use the full set of active parameter values carried in the keyframe's payload to establish a complete rendering state. This includes the precise position, gain, and other attributes for every audio object and channel at that exact moment. Because the keyframe provides a self-contained snapshot of the audio scene, the device can begin decoding and rendering immediately from that point, resulting in glitch-free playback without requiring any data from earlier in the bitstream.

Signaling the synchronization parameter can also allow for signaling metadata at a varying rate within a single bitstream by generating synchronization parameters at irregular intervals. In a complex audio mix, metadata for a fast-moving object might be updated frequently with many synchronization parameters close together, while metadata for a stationary background ambience might be signaled only once at the beginning of a scene. This adaptive signaling rate optimizes the bitrate by transmitting metadata only when it changes.

To ensure a clean start at any seek point, a synchronization parameter can be configured to include a complete set of all active parameter values. This establishes an initial, absolute state for the renderer. Rather than signaling just a change or delta value, this “full state” parameter acts as a reset point, guaranteeing that playback is correct even if the preceding data is unavailable or corrupted, which supports robust streaming and seeking.

The payload of a single synchronization parameter can also be defined to span a duration of multiple audio frames. This further decouples the metadata timeline from the audio frame timeline. For example, a single synchronization parameter could describe a gradual volume fade that occurs over one second. If the audio frame duration is 20 milliseconds, this single metadata block would apply its effect smoothly across 50 consecutive audio frames, providing an efficient way to signal continuous changes.

In some implementations, a synchronization parameter can be used to signal a change in the signaling mode itself, further optimizing for bitrate. For example, an encoder can generate a synchronization parameter to switch from a mode that sends absolute position coordinates to a more efficient mode that sends small, compressed delta values relative to the previous position. This switch could be triggered algorithmically when preprocessor 105 analyzes a segment of metadata and detects a period of smooth, continuous motion. The detection algorithm might, for instance, calculate the first derivative (the difference between consecutive values) of the metadata over a sliding window.

If the variance of these differences remains below a defined stability threshold for a certain number of frames, the preprocessor triggers the switch to delta mode. The synchronization parameter would signal this transition, and subsequent parameter blocks would contain only the compressed delta values until another synchronization parameter signals a return to absolute mode, for instance, after detecting a large, discontinuous jump in position where the difference exceeds a discontinuity threshold. This allows the system to dynamically select the most efficient encoding strategy based on the nature of the metadata at any given time, minimizing overhead. In some implementations, preprocessor 105 can be configured to consider not only the rate of change but also the perceptual importance of the metadata when selecting an encoding mode. For example, the preprocessor 105 can employ a psychoacoustic model to determine that small variations in the position of a background ambient sound are less perceptible than similar variations in a foreground dialogue object. Based on this determination, preprocessor 105 can select a more aggressive quantization level or a lower signaling rate for the background sound's metadata, even if its rate of change is high, thereby achieving further bitrate reductions without compromising the listener's perceived quality of the primary audio elements.

A codec agnostic container 215 can include parameters associated with a scalable channel layout configuration. The scalable channel layout configuration can include information associated with the configuration of scalable channel audio. The scalable channel layout configuration can include parameters representing a channel group, a number of layers, a channel audio layer configuration, a speaker layout, an output-gain-is-present indicator, a reconstruction gain-is-present indicator, a loudness, an output gain indicator, an output gain, and the like. The channel group can be a set of substreams configured to provide a spatial resolution of audio contents by itself or configured to provide an enhanced spatial resolution of audio contents by combining with the preceding channel groups within the audio frames. The number of layers can indicate the number of channel groups for scalable channel audio.

The channel audio layer configuration can be a data structure that provides the information regarding the configuration of a channel group(s) for scalable channel audio. The speaker layout can indicate the channel layout for the channels to be reconstructed from the precedent channel group(s) and the current channel group(s) among channel group(s) for scalable channel audio. The output-gain-is-present indicator can indicate whether output gain information fields for the channel group(s) is/are present. The reconstruction gain is present indicator can indicate whether reconstruction gain information fields for the channel group(s) is included in the channel group(s) gain information block. The loudness can indicate the loudness value of the downmixed channels, for the channel layout, which is indicated by speaker layout, from the original channel audio. The output gain indicator can indicate the channels which output gain is applied to. The output gain can indicate the gain value to be applied to the mixed channels which are indicated by the output gain indicator. The scalable channel layout configuration can include other data not discussed above. However, additional scalable channel layout configuration information may be discussed below.

The codec agnostic container 215 can include parameters associated with an ambisonics configuration. The ambisonics configuration can include information associated with the ambisonics audio. The ambisonics configuration can include parameters representing an ambisonics mode, an output channel count, a substream count, a channel mapping, a coupled substream count, a de-mixing matrix, and the like. The ambisonics mode can specify the method of coding Ambisonics. The output channel count can specify a number of channels or channel count. The substream count can specify a number of audio substreams. Channel mapping can indicate a channel mapping associated with, for example speakers. The coupled substream count can specify the number of referenced substreams that are coded as coupled stereo channels. The de-mixing matrix can also indicate a channel mapping associated with, for example speakers. The ambisonics configuration can include other information not discussed above. However, additional ambisonics configuration information may be discussed below.

The codec agnostic container 215 can include information associated with a de-mixing mode to be used to reconstruct output channel audio according to the speaker layout. The codec agnostic container 215 can include a parameter(s) representing the reconstruction gain. The codec agnostic container 215 can include a parameter(s) representing the gain values used for a down-mixer. The codec agnostic container 215 can include parameters representing the mix target, mix loudness, and mix gain. The codec agnostic container 215 can include parameters representing other information not discussed above. However, additional parameter(s) included in the codec agnostic container 215 may be discussed below.

In some implementations, the codec associated with the codec represented by the codec identification can have limitations associated with parameters that would be included in a codec agnostic container 215. For example, an Opus codec may be limited to two (2) channels. Therefore, if the codec represented by the codec identification is Opus, the channel count (set equal to two) could be included in the codec dependent container 210 (e.g., by the container generator 305) instead of the codec agnostic container 215. In an example implementation, any information and/or parameters (described above) that are not in the codec dependent container 210 can be in the codec agnostic container 215.

The file packager 115 can include a payload generator 310 block, a header generator 315 block, a package generator 320 block, a queue 325 block, and an audio merge module 330 block. The package generator 320 can be configured to generate an audio package 10 including, the header 240, a codec agnostic container 215 and/or a codec dependent container 210. The codec agnostic container 215 block can include at least one parameter representing time-varying and/or non-time varying data associated with playback of the audio data.

In an example implementation, audio data from two or more channels, two or more streams, two or more substreams, and the like can be included in the audio package 10. After the package generator 320 generates a package, the package can be stored in queue 325 (e.g., a memory). Then, each of the packages stored in queue 325 can be merged by the audio merge module 330 to generate the audio package 10 that includes two or more channels, two or more streams, two or more substreams, and the like.

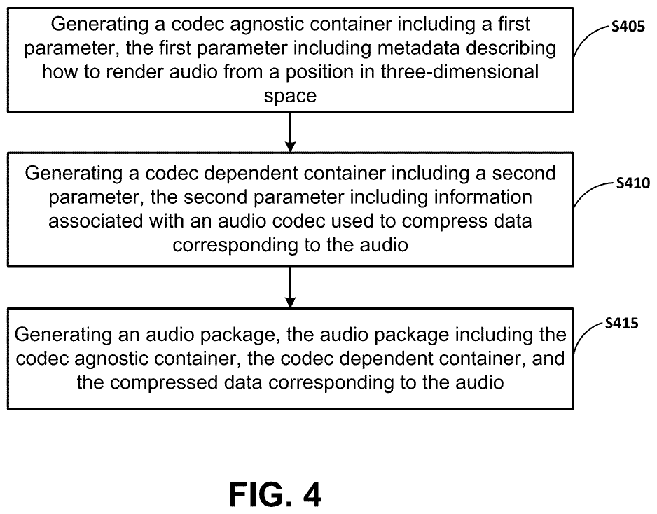

Another use case can be a movie streaming application, a filmmaker may want dialogue to sound centered and clear on a TV soundbar, but intimate and close for a user listening on headphones. Instead of creating two separate, large audio tracks for the entire film, the disclosed system allows the filmmaker to store the dialogue audio only once. Two small, separate sets of metadata are then created: one that instructs a soundbar to play the audio from a central point, and another that tells the headphone renderer to place the sound much closer to the listener. This saves significant storage and streaming bandwidth while delivering a tailored experience for each user.
Example 1. FIG. 4 is a block diagram of a method of generating an audio package according to an example implementation. As shown in FIG. 4, in step S405 generating a codec agnostic container including a first parameter, the first parameter including metadata describing how to render audio in three-dimensional space, the metadata including at least one of a position, a size, or a diffuseness attribute. In some implementations, the metadata can be time-stamped metadata. In some implementations, the metadata can describe how to render audio from a position in three-dimensional space. In some implementations, the metadata can have a timing that is decoupled from a frame rate of the audio. In step S410 generating a codec dependent container including a second parameter, the second parameter including information associated with an audio codec used to compress data corresponding to the audio. In step S415 generating an audio package, the audio package including the codec agnostic container, the codec dependent container, and the compressed data corresponding to the audio. In some implementations, the metadata further includes a directivity attribute. In some implementations, the compressed data corresponding to the audio or a link to compressed data corresponding to the audio. In some implementations, the compressed data corresponding to the audio in the form of a link to the compressed data. In some implementations, metadata timing can be decoupled via parameter blocks. In some implementations, the metadata can be arranged in a parameter block having a time interval decoupled from an audio frame time interval of the audio. In some implementations, the metadata included in the codec agnostic container can be independent of an audio codec used to compress data corresponding to the audio.
Example 2. The method of Example 1 can further include, for example, including, either in the codec agnostic container including the first parameter or in a second codec agnostic container distinct from the codec agnostic container including the first parameter, a third parameter describing how to render the audio from a second position in the three-dimensional space and linking both the first parameter and the second parameter to a same audio substream. Alternatively, or in addition, referencing a same audio substream from both the first parameter and the second parameter.
Example 3. The method of Example 1, wherein the metadata can be represented in a parameter block, the method can further include signaling, in a keyframe, a span of multiple audio frames, defining a duration associated with the parameter block to be different from a duration of a single audio frame, and applying the metadata in the parameter block across the span of audio frames.
Example 4. The method of Example 1 can further include generating a first parameter definition having a first multiplication factor, generating a second parameter definition having a second multiplication factor different from the first multiplication factor, and selectively applying either the first parameter definition or the second parameter definition to represent the metadata depending on which of the first parameter definition and the second parameter definition can represent the metadata with sufficient precision and range with a minimum number of bits.
Example 5. The method of Example 1 can further include parsing a bitstream to identify the codec agnostic container and a corresponding compressed audio substream, decompressing the audio substream to generate a mono audio channel, and processing the mono audio channel based on the metadata to place the mono audio channel at the position in three-dimensional space. Alternatively, or in addition, formatting the audio package such that the compressed data corresponding to the audio is decompressible into a mono audio channel based on the codec dependent container, and the mono audio channel can be renderable at the position in three-dimensional space based on the metadata in the codec agnostic container.
Example 6. The method of Example 1 can further include associating the metadata with a first audio substream within a bitstream, including, in the codec agnostic container, loudness information for the first audio substream and for a second audio substream, and generating instructions for normalizing loudness of the first audio substream and the second audio substream before mixing.
Example 7. The method of Example 1 can further include receiving a first audio stream and a second audio stream, wherein the first audio stream has a first audio frame size and the second audio stream has a second audio frame size different than the first audio frame size, generating the codec agnostic container to include timing information decoupled from frame boundaries of the first audio stream and the second audio stream, and generating a package including the first audio stream, the second audio stream, and the codec agnostic container to enable asynchronous merging.
Example 8. The method of Example 1 can further include generating a parameter block including the metadata, wherein the parameter block can be associated with a first period on a timeline and using metadata from the parameter block or a default metadata for rendering the audio in a second period on the timeline subsequent to the first period.
Example 9. The method of Example 1, wherein the first parameter can specify a speaker layout that is not a predefined layout, the method can further include receiving the codec agnostic container at a playback device, mapping the audio to a layout associated with speakers of the playback device, and panning the audio if the position does not directly correspond to one of the speakers of the playback device. Alternatively, or in addition, generating the first parameter to include coordinates for the speaker layout to enable a playback device to map the audio to a physical speaker layout and pan the audio if the position does not directly correspond to one of the speakers of the physical speaker layout.
Example 10. The method of Example 1 can further include parsing the audio package to extract the codec dependent container and compressed audio data, decompressing the compressed audio data based on the second parameter in the codec dependent container to generate decompressed audio data, and generating an audio presentation based on the decompressed audio data and the metadata in the codec agnostic container. Alternatively, or in addition, configuring the audio package to be parsed to extract the codec dependent container and the compressed data, wherein the compressed data is decompressible based on the second parameter and renderable as an audio presentation based on the metadata in the codec agnostic container.
Example 11. The method of Example 1 can further include identifying, from the second parameter, the audio codec used to compress the data, selecting a decoder corresponding to the identified audio codec, and decompressing, using the selected decoder, the compressed data corresponding to the audio. Alternatively, or in addition, formatting the second parameter to identify the audio codec used to compress the data to enable selection of a decoder corresponding to the audio codec for decompressing the compressed data corresponding to the audio.
Example 12. The method of Example 1 can further include generating a package including the codec dependent container into a first audio package, generating a second audio package including the compressed data, and linking the first audio package to the second audio package using a substream identification parameter included in the codec dependent container.
Example 13. The method of Example 1 can further include generating the audio package including the codec dependent container and a link to the compressed data, and transmitting the audio package in a bitstream to a playback device, wherein the codec dependent container further includes a codec configuration identification parameter and an audio element identification parameter.
Example 14. The method of Example 1, wherein the audio package can include a first package, a second package, and a third package the codec dependent container is part of the first package, the method can further include linking the first package to a second package using an audio element identification parameter in the codec dependent container, and linking the second package to a third package including the compressed data using a substream identification parameter, wherein the second parameter in the codec dependent container specifies the audio codec for decompressing the compressed data in the third package.
Example 15. The method of Example 1 can further include generating a synchronization parameter configured to signal a seek point within a bitstream that includes the audio package, wherein the seek point can be configured to enable playback to begin without reference to preceding data and the synchronization parameter can be included in the codec agnostic container.
Example 16. The method of Example 1 can further include generating a first keyframe including a first size corresponding to a first number of audio frames and generating a second keyframe within a same bitstream, the second keyframe including a second size corresponding to a second number of audio frames different from the first number of audio frames.
Example 17. The method of Example 4, wherein selectively applying either the first parameter definition or the second parameter definition can be based on an analysis of a dynamic range and a required precision of the metadata within a given segment and the analysis can include calculating a maximum absolute value and a minimum step size from the metadata in the segment.
Example 18. The method of Example 1 can further include generating a synchronization parameter configured to signal a switch between a first signaling mode and a second signaling mode, wherein the first signaling mode can include sending absolute values for the metadata, and the second signaling mode can include sending delta values relative to a previous value.
Example 19. The method of Example 17, wherein the analysis can include calculating a maximum absolute value and a minimum step size from the metadata in the segment.
Example 20. The method of Example 19 can further include iterating through a plurality of available parameter definitions, each having a respective multiplication factor and bit depth and selecting a parameter definition that accommodates the maximum absolute value without overflow and represents the minimum step size without quantization to zero.
Example 21. The method of Example 20, wherein accommodating the maximum absolute value can include verifying that the representable range of the parameter definition, as determined by its bit depth, is sufficient to contain the maximum absolute value.
Example 22. The method of Example 20, wherein representing the minimum step size can include verifying that the precision of the parameter definition, as determined by its multiplication factor, is sufficient to represent the minimum step size as a non-zero value.
Example 23. The method of Example 1, wherein the metadata can be generated by translating a continuous automation curve from a source audio authoring tool into a set of discrete, time-stamped values.
Example 24. The method of Example 23, wherein the continuous automation curve can be a Bézier curve, and the translation can be performed using an adaptive sampling algorithm.
Example 25. The method of Example 24, wherein the adaptive sampling algorithm can vary a sampling rate of the curve based on a rate of change of the curve, wherein the sampling rate is increased during periods of high curvature and decreased during periods of low curvature.
Example 26. The method of Example 25, wherein the adaptive sampling algorithm can include calculating a deviation between the curve and a line segment connecting two sample points and recursively inserting an intermediate sample point if the deviation exceeds a predetermined error threshold.
Example 27. The method of Example 23, wherein the resulting time-stamped values can be encoded as a sequence of values within a single parameter block whose duration is set to span an entire automation event defined by the continuous automation curve.
Example 28. The method of Example 8 can further include explicitly signaling whether the renderer should use the last known value or the default value during the gap.
Example 29. The method of Example 28, wherein signaling for the renderer to use the default value can include generating and transmitting a parameter block that specifies a duration for the gap but contains an empty or null value payload.
Example 30. The method of Example 29, wherein the empty or null value payload can be configured to be interpreted by a renderer as an instruction to apply the default value for the specified duration.
Example 31. The method of Example 30, wherein the default value can be specified in a parameter definition referenced by a parameter identification in the parameter block.
Example 32. The method of Example 28, wherein the last known value can be used by the renderer in response to an omission of any parameter block for the metadata, distinguishing it from the explicitly signaled empty parameter block.
Example 33. The method of Example 18, wherein the switch can be triggered by an analysis of a characteristic of the metadata over a time-based window.
Example 34. The method of Example 33, wherein the analysis can include calculating a first derivative of the metadata values within the window to determine a rate of change.
Example 35. The method of Example 34, wherein the switch to the second signaling mode can be triggered when a variance of the first derivative remains below a stability threshold, and a switch to the first signaling mode can be triggered when a difference between consecutive values exceeds a discontinuity threshold.
Example 36. The method of Example 1 can further include analyzing the metadata using a psychoacoustic model to determine a perceptual importance of audio associated with the metadata and selecting an encoding mode for the metadata based on the determined perceptual importance to reduce bitrate.
Example 37. The method of Example 36, wherein selecting the encoding mode can include selecting a lower signaling rate or a more aggressive quantization level for metadata determined to have lower perceptual importance.
Example 38. The method of Example 36, wherein the psychoacoustic model can be used to determine that metadata associated with a background ambient sound has lower perceptual importance than metadata associated with a foreground dialogue object.
Example 39. The method of Example 1 can further include generating a symmetry axis parameter defining an axis other than a center azimuth and rendering a stereo pair of audio channels by mirroring a position of a second channel of the stereo pair relative to a first channel of the stereo pair around the defined axis.
Example 40. A method can include any combination of one or more of Example 1 to Example 39.
Example 41. A non-transitory computer-readable storage medium comprising instructions stored thereon that, when executed by at least one processor, are configured to cause a computing system to perform the method of any of Examples 1-40.
Example 42. An apparatus comprising means for performing the method of any of Examples 1-40.
Example 43. An apparatus comprising at least one processor and at least one memory including computer program code, the at least one memory and the computer program code configured to, with the at least one processor, cause the apparatus at least to perform the method of any of Examples 1-40.

Example implementations can include a non-transitory computer-readable storage medium comprising instructions stored thereon that, when executed by at least one processor, are configured to cause a computing system to perform any of the methods described above. Example implementations can include an apparatus including means for performing any of the methods described above. Example implementations can include an apparatus including at least one processor and at least one memory including computer program code, the at least one memory and the computer program code configured to, with the at least one processor, cause the apparatus at least to perform any of the methods described above.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

Further to the descriptions above, a user may be provided with controls allowing the user to make an election as to both if and when systems, programs, or features described herein may enable collection of user information (e.g., information about a user's social network, social actions, or activities, profession, a user's preferences, a user's current location, or sensor data such as head tracking data for spatial audio rendering), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

While example implementations may include various modifications and alternative forms, implementations thereof are shown by way of example in the drawings and will herein be described in detail. It should be understood, however, that there is no intent to limit example implementations to the particular forms disclosed, but on the contrary, example implementations are to cover all modifications, equivalents, and alternatives falling within the scope of the claims. Like numbers refer to like elements throughout the description of the figures.

Some of the above example implementations are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the needed tasks may be stored in a machine or computer readable medium such as a storage medium. A processor(s) may perform the needed tasks.

Specific structural and functional details disclosed herein are merely representative for purposes of describing example implementations. Example implementations, however, be embodied in many alternate forms and should not be construed as limited to only the implementations set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example implementations. As used herein, the term and/or includes any and all combinations of one or more of the associated listed items.

It will be understood that when an element is referred to as being connected or coupled to another element, it can be directly connected or coupled to the other element or intervening elements may be present. In contrast, when an element is referred to as being directly connected or directly coupled to another element, there are no intervening elements present. Other words used to describe the relationship between elements should be interpreted in a like fashion (e.g., between versus directly between, adjacent versus directly adjacent, etc.).

The terminology used herein is for the purpose of describing particular implementations only and is not intended to be limiting of example implementations. As used herein, the singular forms a, an and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example implementations belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example implementations and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative implementations, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining or displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example implementations are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example implementations are not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or implementations herein disclosed irrespective of whether or not that particular combination has been specifically enumerated in the accompanying claims at this time.

What is claimed is:

1. A method comprising:
generating a codec agnostic container including a first parameter, the first parameter including metadata describing how to render audio in three-dimensional space, the metadata including at least one of a position, a size, a directivity or a diffuseness attribute;
generating a codec dependent container including a second parameter, the second parameter including information associated with an audio codec used to compress data corresponding to the audio; and
generating an audio package, the audio package including the codec agnostic container, the codec dependent container, and the compressed data corresponding to the audio.

2. The method of claim 1, wherein the position is a first position and the method further comprises:
including, either in the codec agnostic container including the first parameter or in a second codec agnostic container distinct from the codec agnostic container including the first parameter, a third parameter describing how to render the audio from a second position in the three-dimensional space; and
linking both the first parameter and the second parameter to a same audio substream.

3. The method of claim 1, wherein the metadata is represented in a parameter block, the method further comprising:
signaling, in a keyframe, a span of audio frames;
defining a duration associated with the parameter block to be different from a duration of a single audio frame; and
applying the metadata in the parameter block across the span of audio frames.

4. The method of claim 1, further comprising:
generating a first parameter definition having a first multiplication factor;
generating a second parameter definition having a second multiplication factor different from the first multiplication factor; and
selectively applying either the first parameter definition or the second parameter definition to represent the metadata depending on which of the first parameter definition and the second parameter definition represents the metadata with sufficient precision and range with a minimum number of bits.

5. The method of claim 1, further comprising:
parsing a bitstream to identify the codec agnostic container and a corresponding compressed audio substream;
decompressing the compressed audio substream to generate a mono audio channel; and
processing the mono audio channel based on the metadata to place the mono audio channel at the position in three-dimensional space.

6. The method of claim 1, further comprising:
associating the metadata with a first audio substream within a bitstream;
including, in the codec agnostic container, loudness information for the first audio substream and for a second audio substream; and
generating instructions for normalizing loudness of the first audio substream and the second audio substream before mixing.

7. The method of claim 1, further comprising:
receiving a first audio stream and a second audio stream, wherein the first audio stream has a first audio frame size and the second audio stream has a second audio frame size different than the first audio frame size;
generating the codec agnostic container to include timing information decoupled from frame boundaries of the first audio stream and the second audio stream; and
generating a package including the first audio stream, the second audio stream, and the codec agnostic container to enable asynchronous merging.

8. The method of claim 1, further comprising:
generating a parameter block including the metadata, wherein the parameter block is associated with a first period on a timeline; and
using metadata from the parameter block or default metadata for rendering the audio in a second period on the timeline subsequent to the first period.

9. The method of claim 1, wherein the first parameter specifies a speaker layout that is not a predefined layout, the method further comprising:
receiving the codec agnostic container at a playback device;
mapping the audio to a layout associated with speakers of the playback device; and
panning the audio if the position does not directly correspond to one of the speakers of the playback device.

10. The method of claim 1, further comprising:
parsing the audio package to extract the codec dependent container and compressed audio data;
decompressing the compressed audio data based on the second parameter in the codec dependent container to generate decompressed audio data; and
generating an audio presentation based on the decompressed audio data and the metadata in the codec agnostic container.

11. The method of claim 1, further comprising:
identifying, from the second parameter, the audio codec used to compress the data;
selecting a decoder corresponding to the identified audio codec; and
decompressing, using the selected decoder, the compressed data corresponding to the audio.

12. The method of claim 1, further comprising:
generating a package including the codec dependent container into a first audio package;
generating a second audio package including the compressed data; and
linking the first audio package to the second audio package using a substream identification parameter included in the codec dependent container.

13. The method of claim 1, further comprising:
generating the audio package including the codec dependent container and a link to the compressed data; and
transmitting the audio package in a bitstream to a playback device, wherein the codec dependent container further includes a codec configuration identification parameter and an audio element identification parameter.

14. The method of claim 1, wherein the audio package includes a first package, a second package, and a third package, and the codec dependent container is part of the first package, the method further comprising:
linking the first package to the second package using an audio element identification parameter in the codec dependent container; and
linking the second package to the third package including the compressed data using a substream identification parameter, wherein the second parameter in the codec dependent container specifies the audio codec for decompressing the compressed data in the third package.

15. The method of claim 1, further comprising:
generating a synchronization parameter configured to signal a seek point within a bitstream that includes the audio package, wherein
the seek point is configured to enable playback to begin without reference to preceding data, and
the synchronization parameter is included in the codec agnostic container.

16. The method of claim 1, further comprising:
generating a first keyframe including a first size corresponding to a first number of audio frames; and
generating a second keyframe within a same bitstream, the second keyframe including a second size corresponding to a second number of audio frames different from the first number of audio frames.

17. The method of claim 1, further comprising:
generating a synchronization parameter configured to signal a switch between a first signaling mode and a second signaling mode, wherein the first signaling mode includes sending absolute values for the metadata, and the second signaling mode includes sending delta values relative to a previous value.

18. The method of claim 1, further comprising:
generating a symmetry axis parameter defining an axis other than a center azimuth; and
rendering a stereo pair of audio channels by mirroring a position of a second channel of the stereo pair relative to a first channel of the stereo pair around the axis.

19. A non-transitory computer-readable storage medium comprising instructions stored thereon that, when executed by at least one processor, are configured to cause a computing system to:
generate a codec agnostic container including a first parameter, the first parameter including metadata describing how to render audio in three-dimensional space, the metadata including at least one of a position, a size, a directivity or a diffuseness attribute;
generate a codec dependent container including a second parameter, the second parameter including information associated with an audio codec used to compress data corresponding to the audio; and
generate an audio package, the audio package including the codec agnostic container, the codec dependent container, and the compressed data corresponding to the audio.

20. An apparatus comprising at least one processor and at least one memory including computer program code, the at least one memory and the computer program code configured to, with the at least one processor, cause the apparatus to:
generate a codec agnostic container including a first parameter, the first parameter including metadata describing how to render audio in three-dimensional space, the metadata including at least one of a position, a size, a directivity or a diffuseness attribute;
generate a codec dependent container including a second parameter, the second parameter including information associated with an audio codec used to compress data corresponding to the audio; and
generate an audio package, the audio package including the codec agnostic container, the codec dependent container, and the compressed data corresponding to the audio.
